(19) United States
(12) Patent Application Publication
(10) Pub. No.: US 2020/0036123 A1
(43) Pub. Date: Jan. 30, 2020

(54) ELECTRICAL CONNECTOR

(71) Applicant: LOTES CO., LTD, Keelung (TW)

(72) Inventor: You Hua Cai, Keelung (TW)

(21) Appl. No.: 16/519,109

(22) Filed: Jul. 23, 2019

(30) Foreign Application Priority Data
Jul. 25, 2018 (CN) 201810822543.X

(51) Int. Cl. H01R 12/73; H01R 12/72; H01R 13/115

(52) U.S. Cl. CPC H01R 12/737; H01R 12/721; H01R 2107/00; H01R 13/115; H01R 12/724

(57) ABSTRACT

An electrical connector is used to be electrically connected to a mating component. The electrical connector includes an insulating body, and at least one terminal provided on the insulating body. The terminal has a base and a first arm and a second arm extending upward from the base. The first arm and the second arm are connected to each other to form a contact portion to conductively connect the mating component. Shapes and structures of the first arm and the second arm are different from each other, and a length of a conductive path of the first arm and a length of a conductive path of the second arm are equal to each other. The terminal can reduce delay in a signal transmission process, and improve synchronization and integrity of the signal transmission, thereby improving signal transmission quality.

### CROSS-REFERENCE TO RELATED PATENT APPLICATION

This non-provisional application claims priority to and the benefit of, pursuant to 35 U.S.C. § 119(a), patent application Serial No. CN201810822543.X filed in China on Jul. 25, 2018. The disclosure of the above application is incorporated herein in its entirety by reference.

Some references, which may include patents, patent applications and various publications, are cited and discussed in the description of this disclosure. The citation and/or discussion of such references is provided merely to clarify the description of the present disclosure and is not an admission that any such reference is “prior art” to the disclosure described herein. All references cited and discussed in this specification are incorporated herein by reference in their entireties and to the same extent as if each reference were individually incorporated by reference.

### FIELD

The present invention relates to an electrical connector, and more particularly to an electrical connector used for transmitting a high-speed signal more completely.

### BACKGROUND

The background description provided herein is for the purpose of generally presenting the context of the disclosure. Work of the presently named inventors, to the extent it is described in this background section, as well as aspects of the description that may not otherwise qualify as prior art at the time of filing, are neither expressly nor impliedly admitted as prior art against the present disclosure.

A electrical connector conventionally used in the industry is used for electrically connecting an electronic card to a circuit board. The electrical connector has an insulating body and multiple conductive terminals. The insulating body is concavely provided with an insertion groove, and the insertion groove extends in a longitudinal direction. Two sides of the insertion groove are provided with multiple accommodating grooves correspondingly accommodating the conductive terminals. Each conductive terminal has a base fixed to the corresponding accommodating groove, an extending portion formed upward from the base, and a contact portion formed from a tail end of the extending portion. Each conductive terminal is provided with a slot, which is opened from the contact portion to the base, and the slot runs through and is communicated with the contact portion. Due to the existence of the slot, the extending portion may form a first arm and a second arm. A joint of the first arm and the second arm forms the contact portion, and the first arm is located farther away from the insertion groove than the second arm.

However, in the structure of the conductive terminal along with gradual downward movement of an electronic card in an actual card insertion process, when the electronic card is in contact with the contact portion, transmission of a signal on the contact portion can be divided into two conductive paths. One conductive path passes through the first arm, and the other conductive path passes through the second arm. Further, the length of the conductive path passing through the second arm is shorter than the length of the conductive path passing through the first arm. Thus, in the transmission process of the signal, distortion or loss of signal transmission may occur, and the complete signal cannot be transmitted, thereby affecting the signal transmission between the conductive terminals and the electronic card and resulting in that the electrical connector cannot work normally.

Therefore, a heretofore unaddressed need to design a new electrical connector exists in the art to address the aforementioned deficiencies and inadequacies.

### SUMMARY

The present invention is directed to an electrical connector having equal signal transmission paths.

In order to achieve the foregoing objective, the present invention adopts the following technical solution:

An electrical connector is configured to electrically connect an electronic card to a circuit board. The electrical connector includes: an insulating body, provided on the circuit board, wherein an insertion groove is concavely provided on the insulating body, and the insertion groove extends in a longitudinal direction; and at least one terminal, provided in the insertion groove and electrically connected with the circuit board, wherein the terminal has a base and a first arm and a second arm extending upward from the base, the first arm is located farther away from the insertion groove than the second arm in a transverse direction perpendicular to the longitudinal direction, the first arm and the second arm respectively have a first contact portion and a second contact portion exposed in the insertion groove, the first contact portion and the second contact portion conductively connect a same conductive sheet on the electronic card, shapes and structures of the first arm and the second arm are different from each other, and a length of a conductive path of the first arm and a length of a conductive path of the second arm are equal to each other.

In certain embodiments, the second arm has a bending area, and the bending area is located closer to the base than the second contact portion.

In certain embodiments, the bending area comprises a plurality of bending portions so as to lengthen the conductive path of the second arm, such that the length of the conductive path of the first arm and the length of the conductive path of the second arm equal to each other.

In certain embodiments, the second arm comprises a vertical section and a bending section, and the bending area is provided in the vertical section.

In certain embodiments, the insulating body is provided with at least one accommodating groove to accommodate the at least one terminal, a retaining hole is provided in one side of the accommodating groove, and a retaining portion is punched longitudinally from the base and is retained to the retaining hole.

In certain embodiments, the electrical connector includes a plurality of terminals, wherein the insulating body is provided with a plurality of accommodating grooves, each of the accommodating grooves correspondingly accommodates two of the terminals, the two of the terminals include a first terminal and a second terminal, and the first terminal and the second terminal respectively conductively connect a plurality of conductive sheets in an upper row and a lower row on the electronic card.

In certain embodiments, the first contact portion and the second contact portion of the first terminal conductively connect the conductive sheets in the upper row on the electronic card, and the first contact portion and the second contact portion of the second terminal conductively connect the conductive sheets in the lower row on the electronic card.

In certain embodiments, a first soldering portion extends downward from the base of the first terminal, a second soldering portion extends downward from the base of the second terminal, the first soldering portion and the circuit board are in surface soldering, the second soldering potion and the circuit board are in surface soldering, a bending direction of the first soldering portion and a bending direction of the second soldering portion are opposite to each other, and the first soldering portion and the second soldering portion are located in a same straight line in the transverse direction perpendicular to the longitudinal direction.

Compared with the related art, certain embodiments of the present invention has the following beneficial effects:

The terminal extends upward from the base to form the first arm and the second arm, and the first arm is located farther away from the insertion groove than the second arm. The first arm and the second arm respectively form the first contact portion and the second contact portion to conductively connect the same conductive sheet on the electronic card. The shapes and structures of the first arm and the second arm are different, but the length of the conductive path of the first arm and the length of the conductive path of the second arm are equal to each other. Thus, the terminal can reduce delay in a signal transmission process, and improve synchronization and integrity of the signal transmission, thereby improving signal transmission quality.

An electrical connector is configured to be electrically connected to a mating component. The electrical connector includes: an insulating body; and at least one terminal, provided on the insulating body, wherein the terminal has a base and a first arm and a second arm extending upward from the base, the first arm and the second arm respectively have a first contact portion and a second contact portion to conductively connect the mating component, shapes and structures of the first arm and the second arm are different from each other, and a length of a conductive path of the first arm and a length of a conductive path of the second arm equal to each other.

In certain embodiments, the second arm has a bending area, and the bending area is located closer to the base than the second contact portion.

In certain embodiments, the bending area comprises a plurality of bending portions so as to lengthen the conductive path of the second arm, such that the length of the conductive path of the first arm and the length of the conductive path of the second arm equal to each other.

Compared with the related art, certain embodiments of the present invention has the following beneficial effects:

The terminal extends upward from the base to form the first arm and the second arm, and the first arm is located farther away from the insertion groove than the second arm. The first arm and the second arm are connected to each other to form the contact portion to conductively connect the mating component. The shapes and structures of the first arm and the second arm are different, but the length of the conductive path of the first arm and the length of the conductive path of the second arm are equal to each other. Thus, the terminal can reduce delay in a signal transmission process, and improve synchronization and integrity of the signal transmission, thereby improving signal transmission quality.

An electrical connector is configured to be electrically connected to a mating component. The electrical connector includes: an insulating body; and at least one terminal, provided on the insulating body, wherein the terminal has a base and a first arm and a second arm extending upward from the base, the first arm and the second arm are connected to each other to form a contact portion to conductively connect the mating component, shapes and structures of the first arm and the second arm are different from each other, and a length of a conductive path of the first arm and a length of a conductive path of the second arm are equal to each other.

In certain embodiments, the mating component is an electronic card, the electrical connector is configured to electrically connect the electronic card to a circuit board, an insertion groove is concavely provided on the insulating body, the insertion groove extends in a longitudinal direction, the at least one terminal is provided in the insertion groove and is electrically connected with the circuit board, the first arm is located farther away from the insertion groove than the second arm in a transverse direction perpendicular to the longitudinal direction, and the first arm and the second arm are connected to each other to form the contact portion to conductively connect the electronic card.

In certain embodiments, the electrical connector includes a plurality of terminals, wherein the insulating body is provided with at least one accommodating groove, the accommodating groove correspondingly accommodates two of the terminals, the two of the terminals include a first terminal and a second terminal, the first terminal has an upper contact portion to conductively connect conductive sheets in an upper row on the electronic card, and the second terminal has a lower contact portion to conductively connect conductive sheets in a lower row on the electronic card.

In certain embodiments, a width of each of a part of the conductive sheets in the upper row on the electronic card is smaller than a width of the conductive sheets in the lower row, and a center distance between two adjacent ones of the conductive sheets in the upper row is equal to a center distance between two adjacent ones of the conductive sheets in the lower row.

In certain embodiments, the second arm has a bending area, and the bending area is located closer to the base than the second contact portion.

In certain embodiments, the bending area comprises a plurality of bending portions so as to lengthen the conductive path of the second arm, such that the length of the conductive path of the first arm and the length of the conductive path of the second arm equal to each other.

In certain embodiments, the second arm comprises a vertical section and a bending section, and the bending area is provided in the vertical section.

In certain embodiments, the insulating body is provided with at least one accommodating groove to accommodate the at least one terminal, a retaining hole is provided in one side of the accommodating groove, and a retaining portion is punched longitudinally from the base and is retained to the retaining hole.

In certain embodiments, the retaining portion comprises a horizontal portion formed by bending longitudinally from the base and a vertical portion formed by bending upward from the horizontal portion, and two sides of the vertical direction are protrudingly provided with at least one fastening point to fasten the retaining hole.

Compared with the related art, certain embodiments of the present invention has the following beneficial effects:

The terminal extends upward from the base to form the first arm and the second arm, and the first arm is located farther away from the insertion groove than the second arm. The first arm and the second arm are connected to each other to form the contact portion to conductively connect the conductive sheet on the electronic card. The shapes and structures of the first arm and the second arm are different, but the length of the conductive path of the first arm and the length of the conductive path of the second arm are equal to each other. Thus, the terminal can reduce delay in a signal transmission process, and improve synchronization and integrity of the signal transmission, thereby improving signal transmission quality.

These and other aspects of the present invention will become apparent from the following description of the preferred embodiment taken in conjunction with the following drawings, although variations and modifications therein may be effected without departing from the spirit and scope of the novel concepts of the disclosure.

### BRIEF DESCRIPTION OF THE DRAWINGS

The accompanying drawings illustrate one or more embodiments of the disclosure and together with the written description, serve to explain the principles of the disclosure. Wherever possible, the same reference numbers are used throughout the drawings to refer to the same or like elements of an embodiment, and wherein:

FIG. 1 is a perspective exploded view of an electrical connector according to a first embodiment of the present invention.

FIG. 2 is a perspective exploded view of the electrical connector in FIG. 1 being located on a circuit board.

FIG. 3 is a perspective schematic view of a terminal of the electrical connector according to certain embodiments of the present invention.

FIG. 4 is a front sectional view of FIG. 2 in an A-A direction when no card is inserted therein.

FIG. 5 is a front sectional view of FIG. 4 when a card is inserted therein.

FIG. 6 is an inverted perspective exploded view of the electrical connector according to certain embodiments of the present invention.

FIG. 7 is a perspective schematic view of the terminal being in contact with an electronic card according to certain embodiments of the present invention.

FIG. 8 is a perspective exploded view of a terminal of an electrical connector according to a second embodiment of the present invention.

FIG. 9 is a front sectional view of the electrical connector according to the second embodiment of the present invention when no card is inserted therein.

FIG. 10 is a front sectional view of the electrical connector according to the second embodiment of the present invention when a card is inserted therein.

### DETAILED DESCRIPTION

The present invention is more particularly described in the following examples that are intended as illustrative only since numerous modifications and variations therein will be apparent to those skilled in the art. Various embodiments of the invention are now described in detail. Referring to the drawings, like numbers indicate like components throughout the views. As used in the description herein and throughout the claims that follow, the meaning of “a”, “an”, and “the” includes plural reference unless the context clearly dictates otherwise. Also, as used in the description herein and throughout the claims that follow, the meaning of “in” includes “in” and “on” unless the context clearly dictates otherwise. Moreover, titles or subtitles may be used in the specification for the convenience of a reader, which shall have no influence on the scope of the present invention.

It will be understood that when an element is referred to as being “on” another element, it can be directly on the other element or intervening elements may be present therebetween. In contrast, when an element is referred to as being “directly on” another element, there are no intervening elements present. As used herein, the term “and/or” includes any and all combinations of one or more of the associated listed items.

Furthermore, relative terms, such as “lower” or “bottom” and “upper” or “top,” may be used herein to describe one element's relationship to another element as illustrated in the Figures. It will be understood that relative terms are intended to encompass different orientations of the device in addition to the orientation depicted in the Figures. For example, if the device in one of the figures is turned over, elements described as being on the “lower” side of other elements would then be oriented on “upper” sides of the other elements. The exemplary term “lower”, can therefore, encompasses both an orientation of “lower” and “upper,” depending of the particular orientation of the figure. Similarly, if the device in one of the figures is turned over, elements described as “below” or “beneath” other elements would then be oriented “above” the other elements. The exemplary terms “below” or “beneath” can, therefore, encompass both an orientation of above and below.

As used herein, “around”, “about” or “approximately” shall generally mean within 20 percent, preferably within 10 percent, and more preferably within 5 percent of a given value or range. Numerical quantities given herein are approximate, meaning that the term “around”, “about” or “approximately” can be inferred if not expressly stated.

As used herein, the terms “comprising”, “including”, “carrying”, “having”, “containing”, “involving”, and the like are to be understood to be open-ended, i.e., to mean including but not limited to.

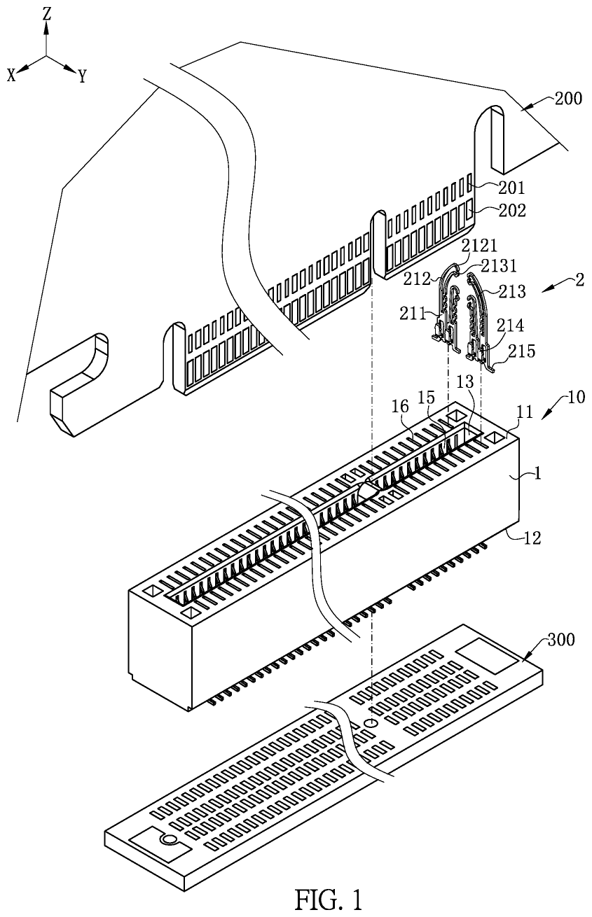

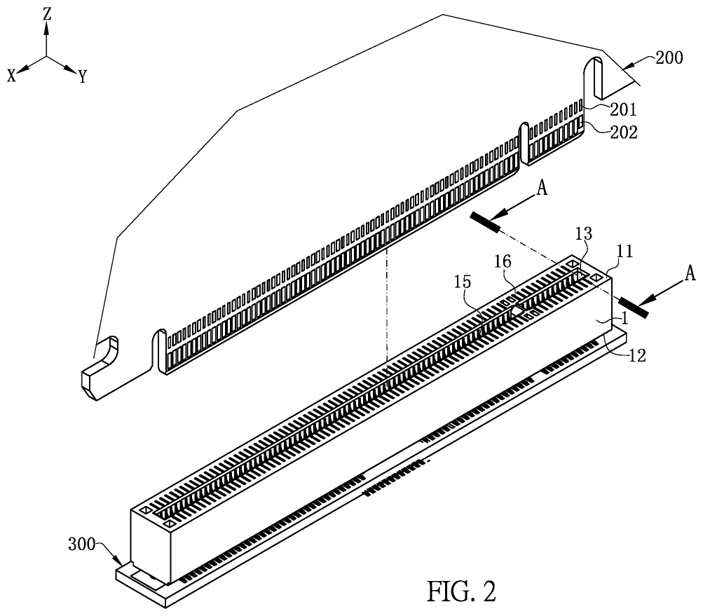

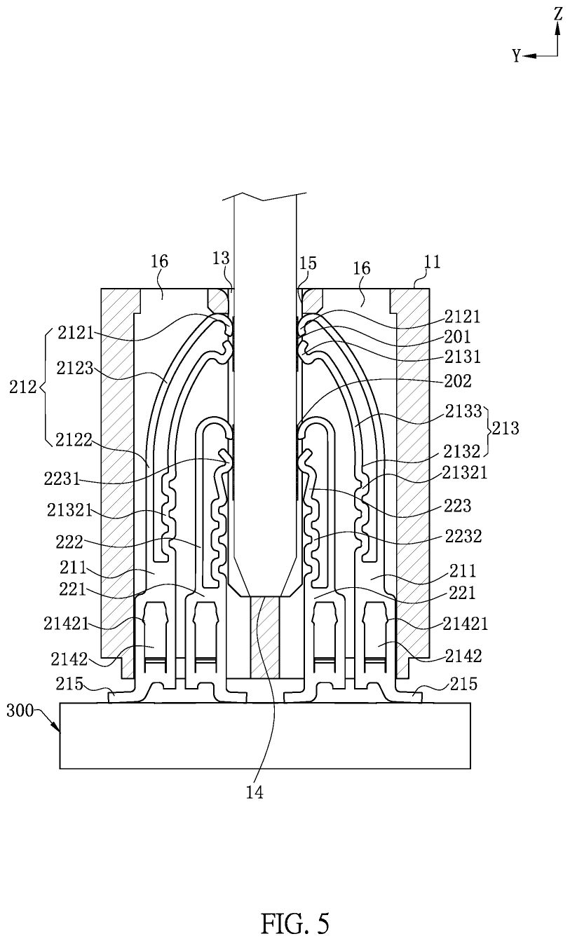

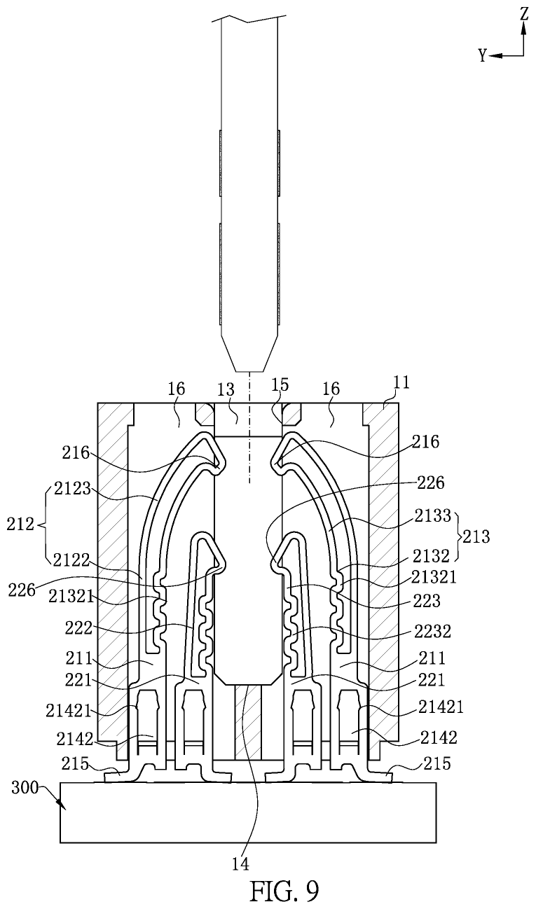

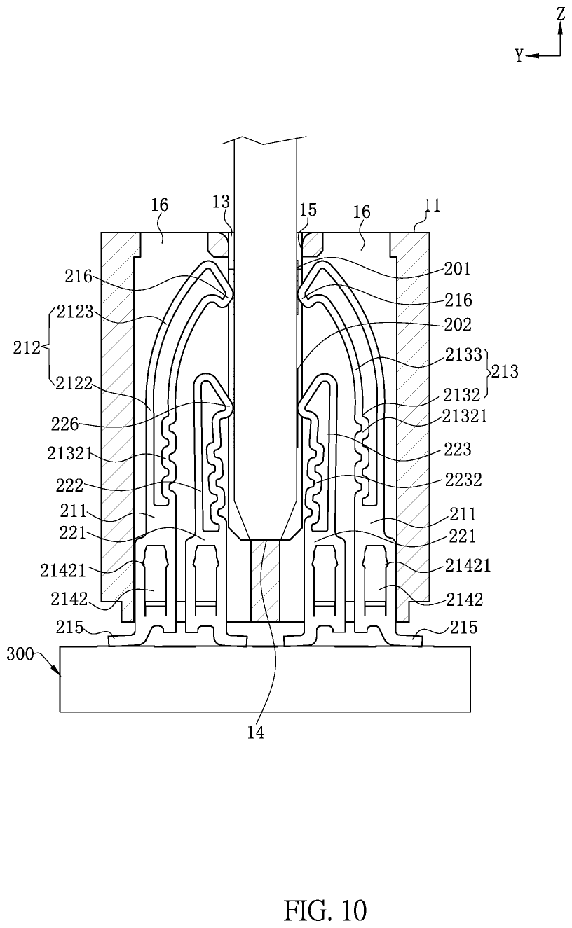

The description will be made as to the embodiments of the present invention in conjunction with the accompanying drawings in FIGS. 1-10. In accordance with the purposes of this invention, as embodied and broadly described herein, this invention, in one aspect, relates to an electrical connector.

FIG. 1 to FIG. 7 show an electrical connector 100 according to a first embodiment of the present invention. The mating component to which the electrical connector 100 is electrically connected is an electronic card 200. Thus, the electrical connector 100 is used for electrically connecting the electronic card 200 to a circuit board 300. The electrical connector 100 includes an insulating body 1 and multiple terminals 2 provided on the insulating body 1.

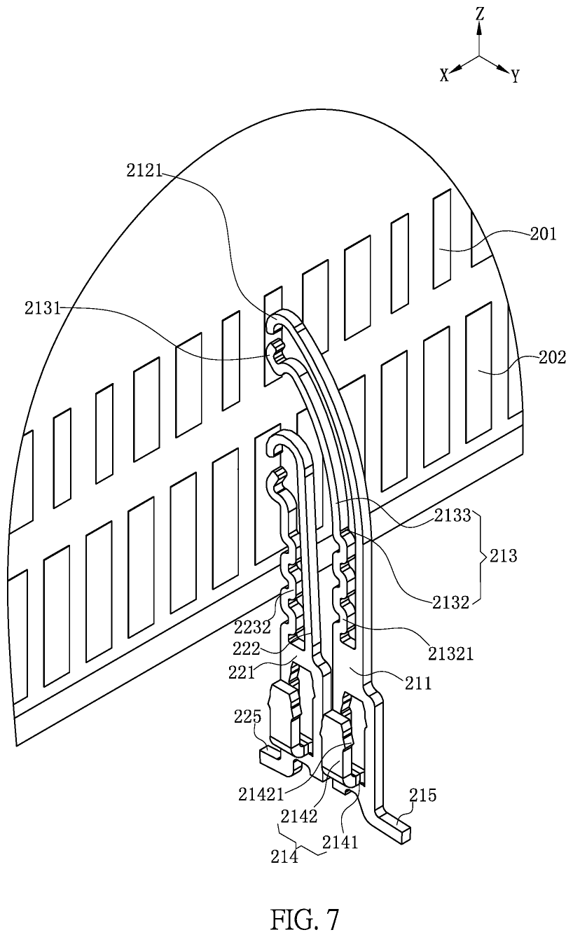

Referring to FIG. 1 and FIG. 7, each of two opposite surfaces of the electronic card 200 is provided with multiple conductive sheets 201 in an upper row and multiple conductive sheets 202 in a lower row. The conductive sheets 201 in the upper row are multiple golden fingers provided at intervals, and the conductive sheets 202 in the lower row are multiple golden fingers provided at intervals. A width of each of a part of the conductive sheets 201 in the upper row is smaller than a width of each of the conductive sheets 202 in the lower row, and a center distance between two adjacent ones of the conductive sheets 201 in the upper row is equal to a center distance between two adjacent ones of the conductive sheets 202 in the lower row. Thus, a transmission wire of the conductive sheets 202 in the lower row can conveniently pass therethrough between the conductive sheets 201 in the upper row.

Referring to FIG. 1, an X-axis is defined as a longitudinal direction, a Y-axis is defined as a transverse direction, and a Z-axis is defined as a vertical direction, and any two directions are perpendicular to each other. The insulating body 1 is roughly in a regular cuboid structure. The insulating body 1 has a mating surface 11 used for mating with the electronic card 200 and an installation surface 12 used for being installed to the circuit board 300. An insertion groove 13 is concavely formed on the mating surface 11, and is used for accommodating the electronic card 200. The insertion groove 13 extends in the longitudinal direction, and the insulating body 1 includes a bottom wall 14 under the insertion groove 13.

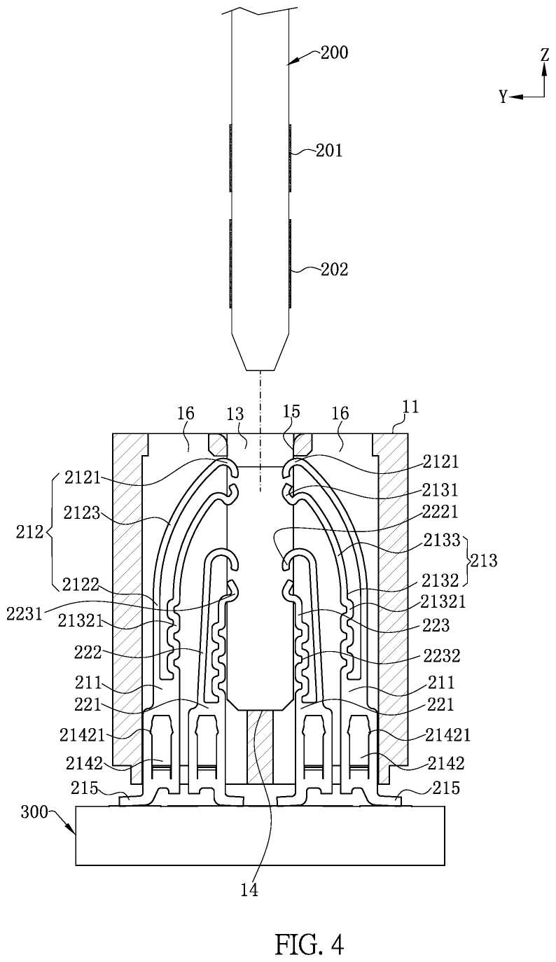

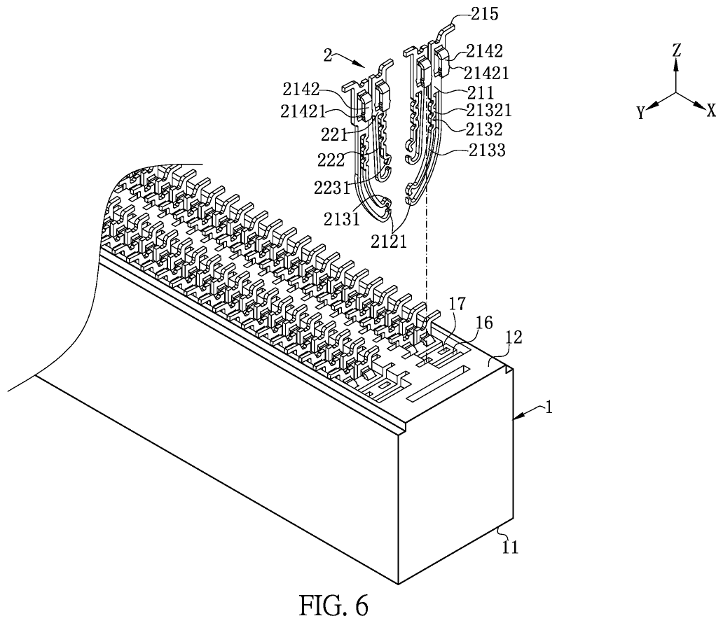

Referring to FIG. 1, FIG. 4 and FIG. 6, the insulating body 1 further includes two side walls 15 located at two sides of the insertion groove 13. Each side wall 15 is provided with multiple accommodating grooves 16. Each accommodating groove 16 runs through the insulating body 1 from top to bottom and is communicated with the insertion groove 13. Two retaining holes 17 are formed in in parallel at one side of the longitudinal direction of the accommodating groove 16. Each retaining hole 17 only runs through a lower surface of the insulating body 1, and does not run through an upper surface of the insulating body 1. Further, a plane on which a downward opening of the retaining hole 17 is located is higher than the installation surface 12.

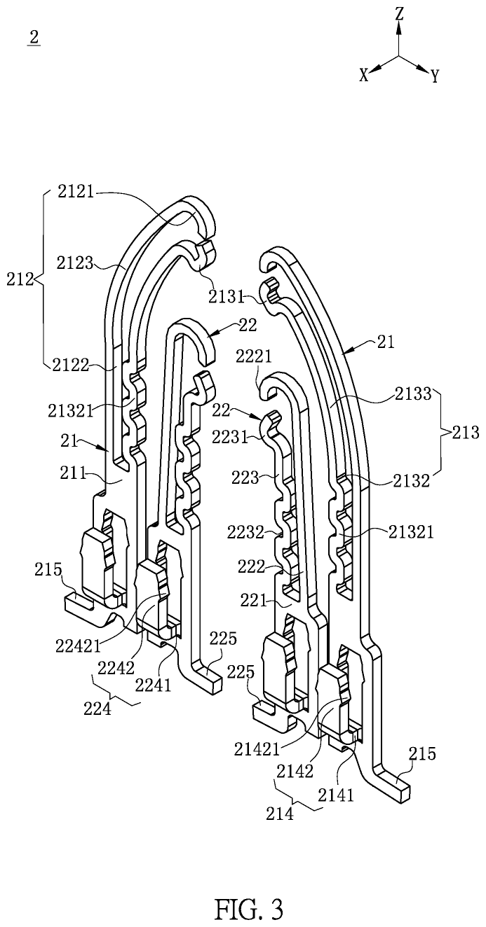

Referring to FIG. 3 to FIG. 5, the terminals 2 are blanking type terminals. The terminals 2 are correspondingly provided in the accommodating grooves 16. Each accommodating groove 16 correspondingly accommodates two terminals 2, and the two terminals 2 include a first terminal 21 and a second terminal 22. The first terminal 21 and the second terminal 22 are provided side by side in the transverse direction, and the first terminal 21 is located farther away from the insertion groove 13 than the second terminal 22. A volume of the first terminal 21 is greater than a volume of the second terminal 22. The first terminal 21 has a base 211, and a first arm 212 and a second arm 213 are formed by extending upward from the base 211. The first arm 212 is located farther away from the insertion groove 13 than the second arm 213 in the transverse direction. The first arm 212 includes a first contact portion 2121 located at a tail end of the first arm 212. The second arm 213 includes a second contact portion 2131 located at a tail end of the second arm 213. The first contact portion 2121 is located above the second contact portion 2131, and the first contact portion 2121 and the second contact portion 2131 simultaneously conductively connect the same one of the conductive sheets 201 in the upper row on the electronic card 200. The first arm 212 has a first vertical section 2122 and a first bending section 2123. The second arm 213 has a second vertical section 2132 and a second bending section 2133. A bending area is provided in the second vertical section 2132, and includes multiple bending portion 21321 to lengthen a conductive path of the second arm 213, such that the length of the conductive path of the first arm 212 and the length of the conductive path of the second arm 213 are equal to each other. The bending directions of two adjacent first bending portions 21321 are opposite to each other in the transverse direction. A first retaining portion 214 is formed by protruding and extending longitudinally from the base 211 of the first terminal 21 and is retained to the retaining hole 17. In the present embodiment, the first retaining portion 214 is formed by punching from the base 211. The first retaining portion 214 includes a horizontal portion 2141 formed by bending longitudinally from the base 211 and a vertical portion 2142 formed by bending upward from the horizontal portion 2141. Two sides of the first vertical portion 2142 are protrudingly provided with multiple fastening points 21421 to fasten the retaining hole 17. The base 211 of the first terminal 21 bends downward and extends to form a first soldering portion 215, and the first soldering portion 215 bends in the transverse direction and extends in a direction away from the insertion groove 13. Referring to FIG. 3, FIG. 4 and FIG. 6, the second terminal 22 has a base 221, and a first arm 222 and a second arm 223 are formed by extending upward from the base 221. The first arm 222 is located farther away from the insertion groove 13 than the second arm 223 in the transverse direction. The first arm 222 includes a first contact portion 2221 located at a tail end of the first arm 222. The second arm 223 includes a second contact portion 2231 located at a tail end of the second arm 223. The first contact portion 2221 is located above the second contact potion 2231, and the first contact portion 2221 and the second contact portion 2231 simultaneously conductively connect the same one of the conductive sheets 202 in the lower row on the electronic card 200. The second arm 223 is provided with multiple bending portions 2232 so as to lengthen a conductive path of the second arm 223, such that the length of the conductive path of the first arm 222 and the length of the conductive path of the second arm 223 are equal to each other. The bending directions of two adjacent bending portions 2232 are opposite to each other in the transverse direction. A second retaining portion 224 is formed by protruding and extending longitudinally from the base 221 of the second terminal 22 and is retained to the retaining hole 17. In the present embodiment, the second retaining portion 224 is formed by punching from the base 221. The second retaining portion 224 includes a horizontal portion 2241 formed by bending longitudinally from the base 221 and a vertical portion 2242 formed by bending upward from the horizontal portion 2241. Two sides of the vertical portion 2242 are protrudingly provided with multiple fastening points 22421 to fasten the retaining hole 17. The base 221 of the second terminal 22 bends downward and extends to form a second soldering portion 225, and the second soldering portion 225 bends in the transverse direction and extends in a direction toward the insertion groove 13. The first soldering portion 215 and the second soldering portion 225 corresponding to the same accommodating groove 16 are located in a same horizontal line in the transverse direction, and the first soldering portion 215 and the second soldering portion 225 are both soldering portions of a surface mounted technology (SMT) type.

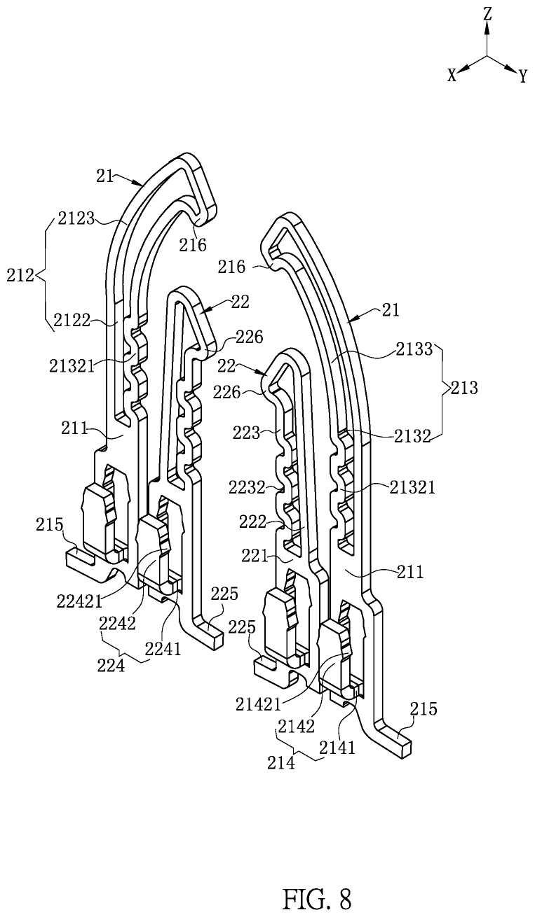

FIG. 8 to FIG. 10 show a second embodiment of the present invention. The second embodiment is different from the first embodiment in that, the first arm 212 of the first terminal 21 and the second arm 213 of the first terminal 21 are connected to each other to form an upper contact portion 216 to conductively connect a same one of the conductive sheets 201 in the upper row on an electronic card 200. The first arm 222 of the second terminal 22 and the second arm 223 of the second terminal 22 are connected to each other to form a lower contact portion 226 to conductively connect a same one of the conductive sheets 202 in the lower row of the electronic card 200. Other structures can refer to the first embodiment.

To sum up, the electrical connector according to certain embodiments of the present invention has the following beneficial effects:

1. The first arm 212 and the second arm 213 in the first terminal 21 conductively connect the same conductive sheet on the electronic card 200 to transmit the same signal. The vertical section 2132 of the second arm 213 is provided with the multiple bending portion 21321 so as to lengthen the second arm 213, thereby achieving the purpose that the length of the conductive path of the first arm 212 and the length of the conductive path of the second arm 213 are equal to each other. Compared with the case where the lengths of the two conductive paths are not equal in the related art, the first terminal 21 can reduce delay in the signal transmission process and improve synchronization and integrity of the signal transmission, thereby improving signal transmission quality. Same principle of the first terminal 21 applies to the second terminal 22.

2. When the first contact portion 2121 on the first arm 212 and the second contact portion 2131 on the second arm 213 of the first terminal 21 conductively connects the electronic card 200, a signal can be transmitted along the first arm 212 and the second arm 213 respectively. Thus, the first arm 212 and the second arm 213 form two independent conductive paths, thereby reducing crosstalk between adjacent first terminals 21 in the longitudinal direction and improving transmission of a high-frequency signal. Same principle of the first terminal 21 applies to the second terminal 22.

3. The first contact portion 2121 and the second contact portion 2131 of the first terminal 21 conductively connect the same conductive sheet on the electronic card 200 simultaneously. By providing dual contact points for the first terminal 21, it is ensured that the first terminal 21 and the electronic card 200 are in effective contact, and the risk that when the electrical connector 100 bears an impact of the external force or is used for a long time, a single contact point cannot ensure effective electrical connection with the electronic card 200, and consequently the electrical connector 100 cannot normally work is lowered.

4. The electronic card 200 is provided with conductive sheets in the upper and lower rows to be electrically connected with the first terminal 21 and the second terminal 22. The width of each of a part of the conductive sheets 201 in the upper row is smaller than the width of each of the conductive sheets 202 in the lower row, and a center distance between two adjacent conductive sheets 201 in the upper row is equal to a center distance between two adjacent conductive sheets 202 in the lower row. In a case where the terminals 2 are dense, such arrangement ensures that the transmission wire of the conductive sheets 202 in the lower row can pass therethrough between the conductive sheets 201 in the upper row, and thereby ensuring stable transmission of a high-speed signal between the two upper and lower rows of terminals 2.

The foregoing description of the exemplary embodiments of the invention has been presented only for the purposes of illustration and description and is not intended to be exhaustive or to limit the invention to the precise forms disclosed. Many modifications and variations are possible in light of the above teaching.

The embodiments were chosen and described in order to explain the principles of the invention and their practical application so as to activate others skilled in the art to utilize the invention and various embodiments and with various modifications as are suited to the particular use contemplated. Alternative embodiments will become apparent to those skilled in the art to which the present invention pertains without departing from its spirit and scope. Accordingly, the scope of the present invention is defined by the appended claims rather than the foregoing description and the exemplary embodiments described therein.

What is claimed is:

1. An electrical connector, configured to electrically connect an electronic card to a circuit board, the electrical connector comprising:
an insulating body, provided on the circuit board, wherein an insertion groove is concavely provided on the insulating body, and the insertion groove extends in a longitudinal direction; and
at least one terminal, provided in the insertion groove and electrically connected with the circuit board, wherein the terminal has a base and a first arm and a second arm extending upward from the base, the first arm is located farther away from the insertion groove than the second arm in a transverse direction perpendicular to the longitudinal direction, the first arm and the second arm respectively have a first contact portion and a second contact portion exposed in the insertion groove, the first contact portion and the second contact portion conductively connect a same conductive sheet on the electronic card, shapes and structures of the first arm and the second arm are different from each other, and a length of a conductive path of the first arm and a length of a conductive path of the second arm are equal to each other.

2. The electrical connector according to claim 1, wherein the second arm has a bending area, and the bending area is located closer to the base than the second contact portion.

3. The electrical connector according to claim 2, wherein the bending area comprises a plurality of bending portions so as to lengthen the conductive path of the second arm, such that the length of the conductive path of the first arm and the length of the conductive path of the second arm equal to each other.

4. The electrical connector according to claim 2, wherein the second arm comprises a vertical section and a bending section, and the bending area is provided in the vertical section.

5. The electrical connector according to claim 1, wherein the insulating body is provided with at least one accommodating groove to accommodate the at least one terminal, a retaining hole is provided in one side of the accommodating groove, and a retaining portion is punched longitudinally from the base and is retained to the retaining hole.

6. The electrical connector according to claim 5, comprising a plurality of terminals, wherein the insulating body is provided with a plurality of accommodating grooves, each of the accommodating grooves correspondingly accommodates two of the terminals, the two of the terminals include a first terminal and a second terminal, and the first terminal and the second terminal respectively conductively connect a plurality of conductive sheets in an upper row and a lower row on the electronic card.

7. The electrical connector according to claim 6, wherein the first contact portion and the second contact portion of the first terminal conductively connect the conductive sheets in the upper row on the electronic card, and the first contact portion and the second contact portion of the second terminal conductively connect the conductive sheets in the lower row on the electronic card.

8. The electrical connector according to claim 6, wherein a first soldering portion extends downward from the first base, a second soldering portion extends downward from the second base, the first soldering portion and the circuit board are in surface soldering, the second soldering potion and the circuit board are in surface soldering, a bending direction of the first soldering portion and a bending direction of the second soldering portion are opposite to each other, and the first soldering portion and the second soldering portion are located in a same straight line in the transverse direction perpendicular to the longitudinal direction.

9. An electrical connector, configured to be electrically connected to a mating component, the electrical connector comprising:
an insulating body; and
at least one terminal, provided on the insulating body, wherein the terminal has a base and a first arm and a second arm extending upward from the base, the first arm and the second arm respectively have a first contact portion and a second contact portion to conductively connect the mating component, shapes and structures of the first arm and the second arm are different from each other, and a length of a conductive path of the first arm and a length of a conductive path of the second arm are equal to each other.

10. The electrical connector according to claim 9, wherein the second arm has a bending area, and the bending area is located closer to the base than the second contact portion.

11. The electrical connector according to claim 10, wherein the bending area comprises a plurality of bending portions so as to lengthen the conductive path of the second arm, such that the length of the conductive path of the first arm and the length of the conductive path of the second arm equal to each other.

12. An electrical connector, configured to be electrically connected to a mating component, the electrical connector comprising:
an insulating body; and
at least one terminal, provided on the insulating body, wherein the terminal has a base and a first arm and a second arm extending upward from the base, the first arm and the second arm are connected to each other to form a contact portion to conductively connect the mating component, shapes and structures of the first arm and the second arm are different from each other, and a length of a conductive path of the first arm and a length of a conductive path of the second arm are equal to each other.

13. The electrical connector according to claim 12, wherein the mating component is an electronic card, the electrical connector is configured to electrically connect the electronic card to a circuit board, an insertion groove is concavely provided on the insulating body, the insertion groove extends in a longitudinal direction, the at least one terminal is provided in the insertion groove and is electrically connected with the circuit board, the first arm is located farther away from the insertion groove than the second arm in a transverse direction perpendicular to the longitudinal direction, and the first arm and the second arm are connected to each other to form the contact portion to conductively connect the electronic card.

14. The electrical connector according to claim 13, comprising a plurality of terminals, wherein the insulating body is provided with at least one accommodating groove, the accommodating groove correspondingly accommodates two of the terminals, the two of the terminals include a first terminal and a second terminal, the first terminal has an upper contact portion to conductively connect conductive sheets in an upper row on the electronic card, and the second terminal has a lower contact portion to conductively connect conductive sheets in a lower row on the electronic card.

15. The electrical connector according to claim 13, wherein a width of each of a part of the conductive sheets in the upper row on the electronic card is smaller than a width of the conductive sheets in the lower row, and a center distance between two adjacent ones of the conductive sheets in the upper row is equal to a center distance between two adjacent ones of the conductive sheets in the lower row.

16. The electrical connector according to claim 12, wherein the second arm has a bending area, and the bending area is located closer to the base than the second contact portion.

17. The electrical connector according to claim 16, wherein the bending area comprises a plurality of bending portions so as to lengthen the conductive path of the second arm, such that the length of the conductive path of the first arm and the length of the conductive path of the second arm equal to each other.

18. The electrical connector according to claim 16, wherein the second arm comprises a vertical section and a bending section, and the bending area is provided in the vertical section.

19. The electrical connector according to claim 12, wherein the insulating body is provided with at least one accommodating groove to accommodate the at least one terminal, a retaining hole is provided in one side of the accommodating groove, and a retaining portion is punched longitudinally from the base and is retained to the retaining hole.

20. The electrical connector according to claim 19, wherein the retaining portion comprises a horizontal portion formed by bending longitudinally from the base and a vertical portion formed by bending upward from the horizontal portion, and two sides of the vertical direction are protrudingly provided with at least one fastening point to fasten the retaining hole.
